(19) United States
(12) Patent Application Publication
(10) Pub. No.: US 2026/0098154 A1
(43) Pub. Date: Apr. 9, 2026

(54) COAL-DERIVED CARBON-BASED INSULATION FOAM AND METHODS OF MAKING THE SAME

(71) Applicant: UNIVERSITY OF WYOMING, Laramie, WY (US)

(72) Inventors: Kam Weng NG, Laramie, WY (US); Md Tarik HOSSAIN, Laramie, WY (US); Chooi Kim LAU, Laramie, WY (US)

(21) Appl. No.: 19/113,740

(22) PCT Filed: Sep. 28, 2023
(86) PCT No.: PCT/US2023/033952

§ 371 Date: Mar. 20, 2025

Related U.S. Application Data
(60) Provisional application No. 63/412,150, filed on Sep. 30, 2022.

(51) Int. Cl. C08L 75/08

(52) U.S. Cl. CPC C08L 75/08; C08L 2203/14

(57) ABSTRACT

Embodiments of the present disclosure related carbon-based foams (CBF). The CBF includes a cured composition. The cured composition includes about 5% to about 20% pyrolysis char (PC) by weight and about 80% to about 95% lignin solution by weight. The lignin solution includes a lignin and a solvent. The solvent includes water, a polyol and a polyisocyanate. A method of making a composition includes grinding and sieving a pyrolysis char (PC) to form a PC powder; mixing a lignin with a solvent to form a lignin solution; mixing the PC powder with the lignin solution to form a lignin-PC solution; mixing a surfactant and a catalyst with the lignin-PC solution to form a raw materials mixture; mixing a foaming agent with the raw materials mixture to form a lignin-PC foam; and curing the lignin-PC foam to form a CBF.

### BACKGROUND

### Field

Embodiments of the present disclosure generally relate to insulation foams and materials. In particular, the disclosure relates to insulation foams and methods of fabricating insulation foams using coal-derived pyrolysis char, lignin, and other chemical materials.

### Description of Related Art

Coal currently serves an important role as an energy source but the increasing demand for renewable energy has reduced the production and consumption of coal in the United States of America (USA). Coal is carbon-rich, and its use in energy generation may affect atmospheric CO₂ levels. The air pollution and global environmental issues associated with the combustion of coal have limited the continuous application of coal in energy production. Specifically, according to the Bureau of Safety and Environmental Enforcement (BSEE), global warming that results from various greenhouse gas emissions is partly due to fossil fuel burning, such as the combustion of coal. Therefore, several studies are being conducted to create new non-energy and fuel opportunities for Wyoming coal.

Wyoming serves as one of the major producers of coal in the USA. Wyoming Powder River Basin (PRB) coal plays an important role in the Wyoming energy industry. However, renewable energy is slowly replacing the coal industry, causing the market price of coal to drop. Thus, to attract new investment through technological innovation and support coal mine operations, environmentally friendly methods to create new diversified coal products are needed. One concern is characterizing the eco-efficiency of pyrolysis char (PC) products, which includes life-cycle metrics. In addition, the worldwide demand for energy, and thus energy saving technologies, is rising. The rising energy demand is expected to be more severe, especially in developing countries, due to the rapid growth of new buildings. However, the use of energy efficient technologies is often not gaining sufficient attention. It is reported that building consume up to 33% of total energy consumption, and half of that energy is lost through building facades (i.e., walls). Thus, reducing the thermal conductivity in building facades may decrease energy consumption in structures.

Therefore, there is a need for improved insulation foams and methods of fabricating insulation foams using coal-derived pyrolysis char, lignin, and other chemical materials.

### SUMMARY

In one embodiment, a composition is described herein. The composition includes about 5% to about 20% pyrolysis char (PC) by weight and about 80% to about 95% lignin solution by weight. The lignin solution includes a lignin and a solvent. The solvent includes water, a polyol, and a polyisocyanate.

In another embodiment, a carbon based foam (CBF) is described herein. The CBF includes a cured composition. The cured composition includes about 5% to about 20% pyrolysis char (PC) by weight and about 80% to about 95% lignin solution by weight. The lignin solution includes a lignin and a solvent. The solvent includes water, a polyol, and a polyisocyanate.

In another embodiment, a method of forming a carbon based foam (CBF) from a composition is described herein. The method of making a composition includes grinding and sieving a pyrolysis char (PC) to form a PC powder; mixing a lignin with a solvent to form a lignin solution; mixing the PC powder with the lignin solution to form a lignin-PC solution; mixing a surfactant and a catalyst with the lignin-PC solution to form a raw materials mixture; mixing a foaming agent with the raw materials mixture to form a lignin-PC foam; and curing the lignin-PC foam to form a CBF.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a flow diagram of a method of forming carbon based foam (CBF), according to embodiments.

FIG. 2 is a graph illustrating foam density versus PC particle size, according to embodiments.

FIG. 3 is a graph illustrating foaming ratio versus PC particle size, according to embodiments.

FIG. 4 is a graph illustrating thermal conductivity versus the PC particle size, according to embodiments.

FIG. 5A is a graph illustrating the compressive stress versus strain diagram for the F-75 CBF sample, according to embodiments.

FIG. 5B is a graph illustrating the compressive stress versus strain diagram for the F-150 CBF sample, according to embodiments.

FIG. 5C is a graph illustrating the compressive stress versus strain diagram for the F-300 CBF sample, according to embodiments.

FIG. 6 is a graph illustrating the CBF density versus lignin/PC ratio, according to embodiments.

FIG. 7 is a graph illustrating the foaming ratio versus lignin/PC ratio, according to embodiments.

FIG. 8 is a graph illustrating the thermal conductivity versus lignin/PC ratio, according to embodiments.

FIG. 9A is a graph illustrating the compressive stress versus strain diagram for the F-L/C-1.00 CBF sample, according to embodiments.

FIG. 9B is a graph illustrating the compressive stress versus strain diagram for the F-L/C-0.75 CBF sample, according to embodiments.

FIG. 9C is a graph illustrating the compressive stress versus strain diagram for the F-L/C-0.50 CBF sample, according to embodiments.

FIG. 10 is a graph illustrating the foam density versus solvent ratio, according to embodiments.

FIG. 11 is a graph illustrating the foaming ratio versus solvent ratio, according to embodiments.

FIG. 12 is a graph illustrating the thermal conductivity versus solvent ratio, according to embodiments.

FIG. 13A is a graph illustrating the compressive stress versus strain diagram for the F-FA/Sol-1.00 CBF sample, according to embodiments.

FIG. 13B is a graph illustrating the compressive stress versus strain diagram for the F-FA/Sol-0.75 CBF sample, according to embodiments.

FIG. 13C is a graph illustrating the compressive stress versus strain diagram for the F-FA/Sol-0.50 CBF sample, according to embodiments.

FIG. 14 is a graph illustrating the foam density versus water/PEG ratio, according to embodiments.

FIG. 15 is a graph illustrating foaming ratio versus water/PEG ratio, according to embodiments.

FIG. 16 is a graph illustrating the thermal conductivity versus water/PEG ratio, according to embodiments.

FIG. 17A is a graph illustrating the compressive stress versus strain for the F-W/PEG-0.75 CBF sample, according to embodiments.

FIG. 17B is a graph illustrating the compressive stress versus strain for the F-W/PEG-0.67 CBF sample, according to embodiments.

FIG. 17C is a graph illustrating the compressive stress versus strain for the F-W/PEG-0.50 CBF sample, according to embodiments.

FIG. 18 is a graph illustrating the foam density versus surfactant ratio, according to embodiments.

FIG. 19 is a graph illustrating the foaming ratio versus surfactant ratio, according to embodiments.

FIG. 20 is a graph illustrating thermal conductivity versus surfactant ratio, according to embodiments.

FIG. 21A is a graph illustrating the compressive stress versus strain diagram for a F-S-0.0075 CBF sample, according to embodiments.

FIG. 21B is a graph illustrating the compressive stress versus strain diagram for a F-S-0.0050 CBF sample, according to embodiments.

FIG. 21C is a graph illustrating the compressive stress versus strain diagram for a F-S-0.0025 CBF sample, according to embodiments.

FIG. 22 is a graph illustrating foam density versus surfactant, according to embodiments.

FIG. 23 is a graph illustrating foaming ratio versus surfactant, according to embodiments.

FIG. 24 is a graph illustrating thermal conductivity versus surfactant, according to embodiments.

FIG. 25A is a graph illustrating the compressive stress versus strain diagram for a F-TA CBF sample, according to embodiments.

FIG. 25B is a graph illustrating the compressive stress versus strain diagram for a F-SO CBF sample, according to embodiments.

FIG. 26 is a graph illustrating the foam density versus PC content, according to embodiments.

FIG. 27 is a graph illustrating the foaming ratio versus PC content, according to embodiments.

FIG. 28 is a graph illustrating the thermal conductivity versus PC content, according to embodiments.

FIG. 29A is a graph illustrating the compressive stress versus strain diagram for the F-PC-5 CBF sample, according to embodiments.

FIG. 29B is a graph illustrating the compressive stress versus strain diagram for the F-PC-10 CBF sample, according to embodiments.

FIG. 29C is a graph illustrating the compressive stress versus strain diagram for the F-PC-12.5 CBF sample, according to embodiments.

FIG. 29D is a graph illustrating the compressive stress versus strain diagram for the F-PC-15 CBF sample, according to embodiments.

FIG. 29E is a graph illustrating the compressive stress versus strain diagram for the F-PC-20 CBF sample, according to embodiments.

FIG. 30 is a graph illustrating the thermal conductivity versus strain of CBF, according to embodiments.

FIG. 31 is a graph illustrating the foaming ratio versus pentane content, according to embodiments.

FIG. 32 is a graph illustrating the foam density versus pentane content, according to embodiments.

FIG. 33 is a graph illustrating the thermal conductivity versus pentane content, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to insulation foams and materials. In particular, the disclosure relates to insulation foams and methods of fabricating insulation foams using coal-derived pyrolysis char, lignin, and other chemical materials.

In one embodiment, a composition is described herein. The composition includes about 5% to about 20% pyrolysis char (PC) by weight and about 80% to about 95% lignin solution by weight. The lignin solution includes a lignin and a solvent. The solvent includes water, a polyol and a polyisocyanate.

In another embodiment, a carbon based insulation foam is described herein. The CBF includes a cured composition. The cured composition includes about 5% to about 20% pyrolysis char (PC) by weight and about 80% to about 95% lignin solution by weight. The lignin solution includes a lignin and a solvent. The solvent includes water, a polyol and a polyisocyanate.

In another embodiment, a method of forming a carbon based foam (CBF) from a composition is described herein. The method of making a composition includes grinding and sieving a pyrolysis char (PC) to form a PC powder; mixing a lignin with a solvent to form a lignin solution; mixing the PC powder with the lignin solution to form a lignin-PC solution; mixing a surfactant and a catalyst with the lignin-PC solution to form a raw materials mixture; mixing a foaming agent with the raw materials mixture to form a lignin-PC foam; and curing the lignin-PC foam to form a carbon based foam (CBF).

The inventors have found new and improved methods for fabricating insulation foams and materials from coal-derived pyrolysis char (PC) and lignin. Briefly, raw coal is thermo-chemically converted to produce PC. The resulting PC is then converted to insulation foams and materials.

The desire for environmentally-friendly materials, energy savings, and reduced energy consumption in building materials can be addressed by the building materials described herein. Building materials made with PC material have low density, low thermal conductivity, and high insulative properties. These materials, through recycling/reuse and decreasing the amount of energy usage in fabrication, further lessen the environmental impact of the insulation foams and materials.

The use of headings is for purposes of convenience and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Compositions

Embodiments described herein generally relate to insulation foams and materials. In particular, the disclosure relates to insulation foams and methods of fabricating insulation foams using coal-derived pyrolysis char, lignin, and other chemical materials.

A carbon based foam (CBF) includes lignin and pyrolysis char (PC). The CBF has a foam density of about 0.1 g/cm³ to about 0.33 g/cm³. The CBF has foaming ratio of about 2.46 to about 7.98. The CBF has a thermal conductivity of about 0.042 W/m·K to about 0.087 W/m·K. The CBF has a compression strength of about 200 kPa to about 5000 kPa, such as between 2000 kPa and 4500 kPa.

The CBF has may have about 5% to about 20% PC by weight. The PC particle size may be less than about 300 μm, such as less than 150 μm, such as less than 75 μm. The lignin to PC ratio may be from about 0.5 to about 1.0.

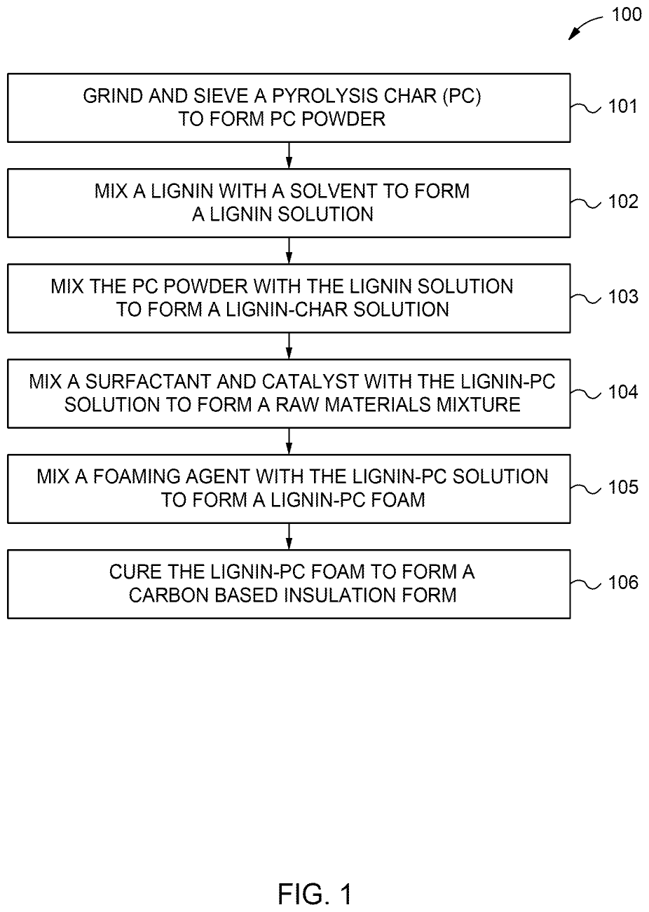

FIG. 1 illustrates a flow diagram of a method 100 of forming carbon based foam (CBF). At operation 101, a pyrolysis char (PC) is ground and sieved to form a PC powder. The PC powder may have a particle size of about 300 μm or less, such as less than about 300 μm, such as less than 150 μm, such as less than 75 μm.

At operation 102, a lignin is mixed with a solvent to form a lignin solution. The solvent includes water, a polyol, and a polyisocyanate. In some embodiments, the solvent includes pentane. The pentane may be about 1% to about 10% by weight of the lignin solution, such as about 2% to about 6% of the total lignin solution. The polyol may include Poly Ethylene Glycol (PEG), diethylene glycol (DEG), polypropylene glycol (PPG), or a combination thereof. The polyisocyanate may include poly methyl diphenyl diisocyanate (pMDI), methylene diphenyl diisocyanate (monomeric MDI), or a combination thereof. The solvent may have a pMDI/(water+PEG) ratio from about 0.5 to about 1.00 by weight. The water/PEG ratio may be from about 0.5 to about 0.75 by weight. The lignin solution may be stirred with a mixing rod/spoon. The lignin solution may be stirred for about 1 minute to about 5 minutes. The lignin solution may be heated in an oven to a temperature of about 65° C. to about 70° C. for about 5 minutes to about 10 minutes. The lignin solution may be stirred for about 1 to about 3 minutes after heating to dissolve all the lignin into the solution.

At operation 103, the PC powder is mixed with the lignin solution to form a lignin-PC solution. The PC powder and lignin solution may be mixed manually at room temperature. At operation 104, a surfactant and a catalyst is mixed with the lignin-PC solution to form a raw materials mixture. Mixing the surfactant and catalysts with the lignin-PC solution may reduce the surface tension and to increase the foaming reaction. The catalyst may include dibutyltin dilaurate (DD), stannous octoate, or a combination thereof. The catalyst content may be from about 0.08% to about 0.1% by weight. The surfactant may include triethylene amine (TA), silicon oil (SO), or a combination thereof. The surfactant/(water+pMDI+PEG) ratio may be from about 0.0025 to about 0.0075 by weight. The surfactant and catalyst solution may be manually mixed for about 15 seconds to about 90 seconds to form the raw materials mixture.

At operation 105, a foaming agent is mixed with the raw materials mixture to form a lignin-PC foam. The lignin-PC solution and foaming agent are stirred vigorously at about 2000 rpm to about 2400 rpm for about 15 to about 20 seconds to start the foaming reaction. The foaming agent may include pMDI, methylene diphenyl diisocyanate (monomeric MDI), or a combination thereof.

At operation 106, the lignin-PC foam is cured to form a carbon based form (CBF). The lignin-PC foam may be cured for about 12 to about 36 hours at a temperature of about 50° C. to about 90° C. before demolding. Demolding may be followed by curing the CBF for about another about 12 hours to about 36 hours of curing at about 90° C. to about 120° C. to remove any excess water from the CBF. Curing the lignin-PC foam lowers the density and thermal properties of the CBF.

### Uses

Embodiments of the present disclosure also generally relate to uses of the compositions described herein. Compositions described herein can also be used for various applications.

Illustrative, but non-limiting, applications include insulation foams for use in construction applications.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### Examples

### Test Methods

The foam density is measured by taking the ratio of mass and volume.

The foaming ratio is calculated by the ratio of final CBF volume and mixture volume before foaming.

The compressive strength is measured using Zwick/Roell Z020 compression testing matchine. The compressive strength of the CBF is measured using ASTM C39.

Thermal conductivity is measured using Hot Disk TPS 1500. The thermal conductivity of the CSUs was measured using ISO 22007-2.

### Experimental

A porous material (e.g., pyrolysis char (PC), pyrolyzed at about 850° C.), and binding material lignin (e.g., sodium lignosulfonate, water-soluble 99.15%) are utilized for the fabrication of the carbon based foam (CBF). Polyethylene glycol (PEG) and polymethylene diphenyl diisocyanate (pMDI) may be used to create the CBF through chemical reactions. PEG may have a number average molecular weight (Mn) of about 400 g/mol. pDMI may have a number average molecular weight (Mn) of about 340 g/mol. Dibutyltin dilaurate (DD), acting as a catalyst, and triethylene amine (TA) (with a purity ≥99.5%) or silicon oil (SO) (with purity=100%), acting as surfactants, may be used in the CBF preparation.

The pyrolysis char (PC) is ground and sieved to obtain a PC powder having a particle size of about 300 μm (e.g., the PC powder is passed through a #200 sieve), about 150 μm (e.g., the PC powder is passed through a #100 sieve), or about 75 μm (e.g., the PC powder is passed through a #50 sieve). The lignin is poured into a solvent (e.g., water and PEG) and stirred with a mixing rod/spoon to form the lignin solution. The lignin and the solvent may be stirred for about 1 minute to about 5 minutes to form the lignin solution. The lignin solution may be put into an oven to heat for 10 minutes to raise the temperature around 65-70° C. The heated lignin solution may be stirred for about another 1 to 3 minutes to dissolve all the lignin into the solution.

The PC powder is added to the lignin solution and mixed manually at room temperature to prepare a lignin-PC solution. A surfactant (e.g., TA/SO) and a catalyst (e.g., DD) solution may be added to the lignin solution to reduce the surface tension and to increase the foaming reaction. The surfactant and catalyst solution includes DD and one of TA or SO. The surfactant and catalyst solution may be mixed manually for about 30 seconds to form the raw materials mixture.

The foaming agent (e.g., pMDI) is added to the mixture and stirred vigorously at about 2200 rpm for about 15-20 seconds to start the foaming reaction and form the lignin-PC foam. The lignin-PC foam prepared from the foaming reaction is cured for about 24 hours at a temperature of about 70° C. to form the CBF. After demolding the CBF, the CBF may be cured for about another 24 hours of curing at about 105° C. to remove any excess water from the CBF.

Table 1 shows a summary of the material quantities for different PC particle sizes. The CBF samples include a CBF sample with PC powder less than 75 μm PC particles (F-75 PC powder), a CBF sample with less than 150 μm particle (F-150 PC powder), and a CBF sample with less than 300 μm particles (F-300 PC powder). The mixing parameters of method 100 may include a lignin/PC ratio of about 1.00, a pMDI/(water+PEG) ratio of about 0.75, a water/PEG ratio of about 0.67, a TA/(water+PEG+pMDI) ratio of about 0.005, and a gross material quantity of 0.08% DD. A (PEG+water)/PC ratio of about 5.83 is maintained to have about 10% PC content.

TABLE 1
Material Quantities for the Lignin-PC Solution.

| PC | Lignin | Water | PEG | pMDI | Surfactant | Catalyst | Total |
|---|---|---|---|---|---|---|---|
| (g) | (g) | (g) | (g) | (g) | (g) | (g) | (g) |
| 8.5 | 8.5 | 19.88 | 29.67 | 38.25 | 0.425 | 0.085 | 105.32 |

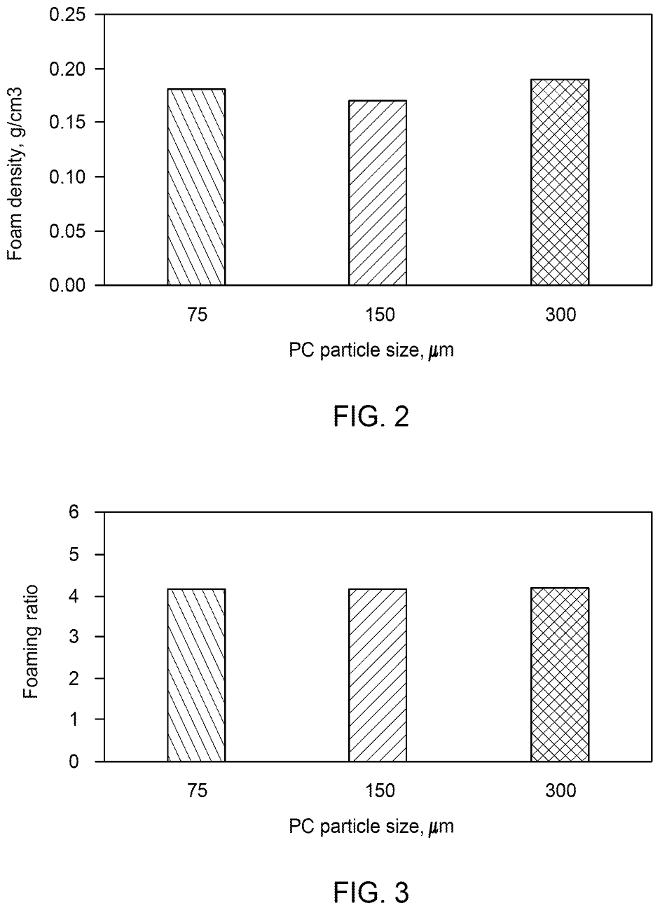

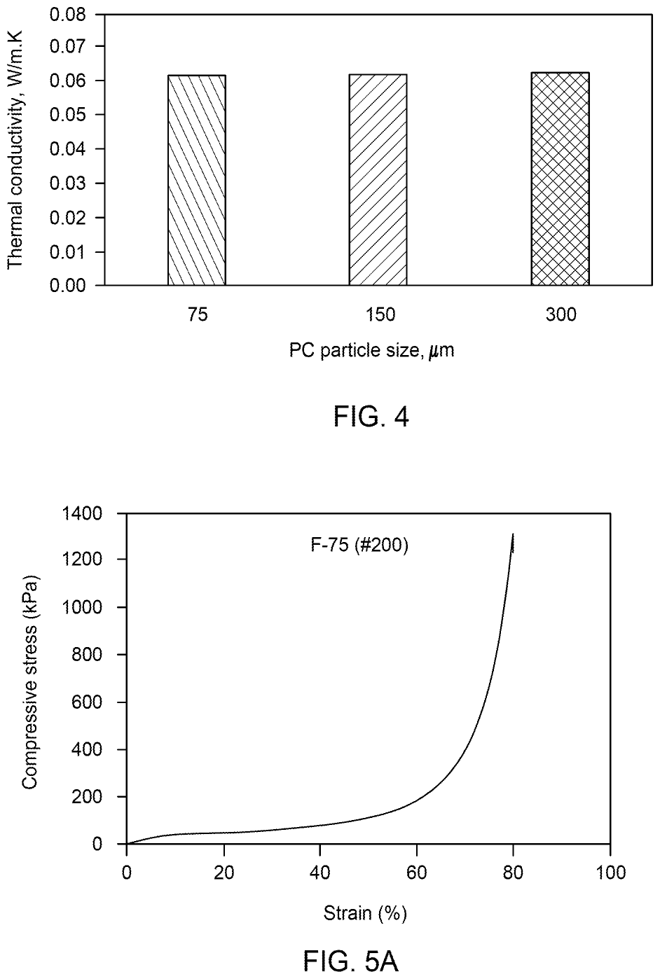

Table 2 shows a summary of the material testing results for carbon based foam (CBF) with varying PC powder particle sizes. FIG. 2 is a graph illustrating foam density versus PC particle size. FIG. 3 is a graph illustrating foaming ratio versus PC particle size. FIG. 4 is a graph illustrating thermal conductivity versus the PC particle size. Densities, foaming ratios, and percent voids may be independent from the PC particle size. Thermal conductivity may increase as particle size increases. The thermal conductivity increased from 0.0616 W/m·K to 0.0618 W/m·K when the PC powder particle size increases from 75 μm to 150 μm, and further increases up to 0.0621 W/m·K for the PC particle size of 300 μm.

TABLE 2
Material Testing Results for Carbon Based Insulation
Foam with Varying PC Particle Size.

| | PC | | | | | |
|---|---|---|---|---|---|---|
| | particle | | | Percent | Thermal | Permanent |
| | size | Density | Foaming | void | conductivity | deformation |
| CBF Name | (μm) | (g/cm³) | ratio | (%) | (W/m · K) | (%) |
| F-75 (#200) | 75 | 0.18 | 4.16 | 75.96 | 0.0616 | 12.12 |
| F-150 (#100) | 150 | 0.17 | 4.16 | 75.94 | 0.0618 | 7.47 |
| F-300 (#50) | 300 | 0.19 | 4.18 | 76.10 | 0.0621 | 12.23 |

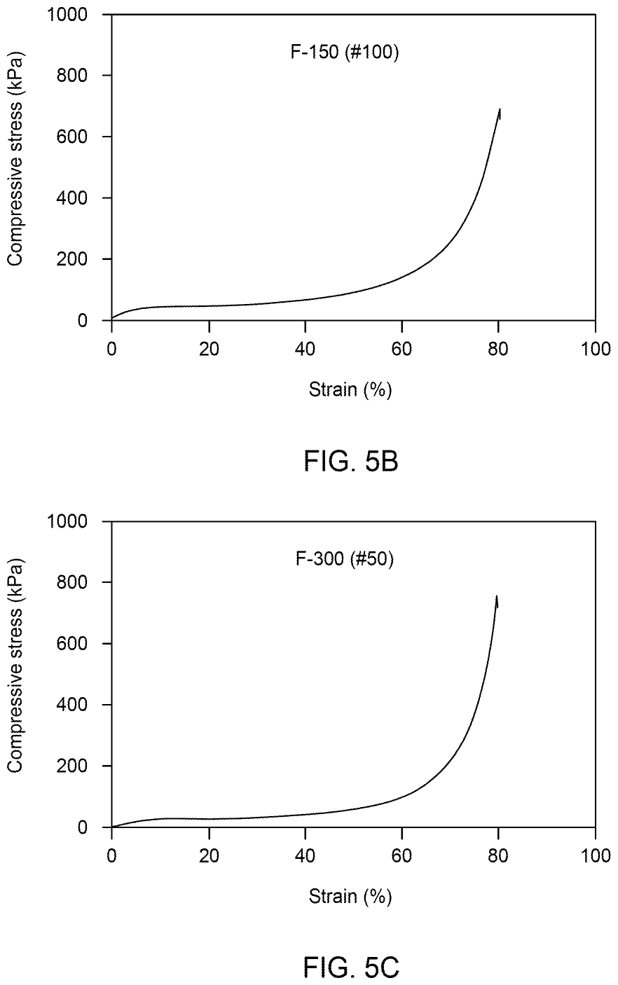

FIG. 5A is a graph illustrating the compressive stress versus strain diagram for the F-75 CBF sample. FIG. 5B is a graph illustrating the compressive stress versus strain diagram for the F-150 CBF sample. FIG. 5C is a graph illustrating the compressive stress versus strain diagram for the F-300 CBF sample. The CBF samples are tested up to 80% deflection and the compressive strength can be compared for 80% strain. After 24 hours of the compression test, the permanent deformation is calculated. The F-150 PC powder has a lower density, grinding energy requirement, and permanent deformation than the F-75 PC powder. The F-150 PC powder has a lower density and thermal conductivity than the F-300 PC powder.

Table 3 shows the material quantities of the CBF samples with different lignin/PC ratios. The CBF samples include a CBF samples with a lignin-PC solution having a mass ratio of about 1.00 (F-L/C-1.00), a CBF sample with a lignin-PC solution having a mass ratio of about 0.75 (F-L/C-0.75), and a CBF sample with a lignin-PC solution having a mass ratio of about 0.50 (F-L/C-0.50). The PC content may be maintained at about 10% with the F-150 PC powder. The mixing parameters include a pMDI/(water+PEG) ratio of about 0.75, a water/PEG ratio of about 0.67, a TA/(water+PEG+pMDI) ratio of about 0.005, and a gross material quantity of about 0.08% DD. The amount of loose PC on the CBF surface increases when the lignin/PC ratio is reduced to 0.75 (F-L/C-0.75) and 0.50 (F-L/C-0.50) from the ratio of 1.00 (F-L/C-1.00), which may be due to the lack of sufficient lignin to bind all the PC. An increase in the amount of loose PC may create problems during the installation of the CBF as insulation material.

TABLE 3
Material Quantities for Different Lignin/PC Ratios.

| | PC | Lignin | Water | PEG | pMDI | Surfactant | Catalyst | Total |
|---|---|---|---|---|---|---|---|---|
| CBF Name | (g) | (g) | (g) | (g) | (g) | (g) | (g) | (g) |
| F-L/C-1.00 | 8.5 | 8.5 | 19.88 | 29.67 | 38.25 | 0.425 | 0.085 | 105.32 |
| F-L/C-0.75 | 8.5 | 6.38 | 20.67 | 30.84 | 38.63 | 0.451 | 0.087 | 105.56 |
| F-L/C-0.50 | 8.5 | 4.25 | 21.31 | 31.81 | 39.84 | 0.465 | 0.088 | 106.27 |

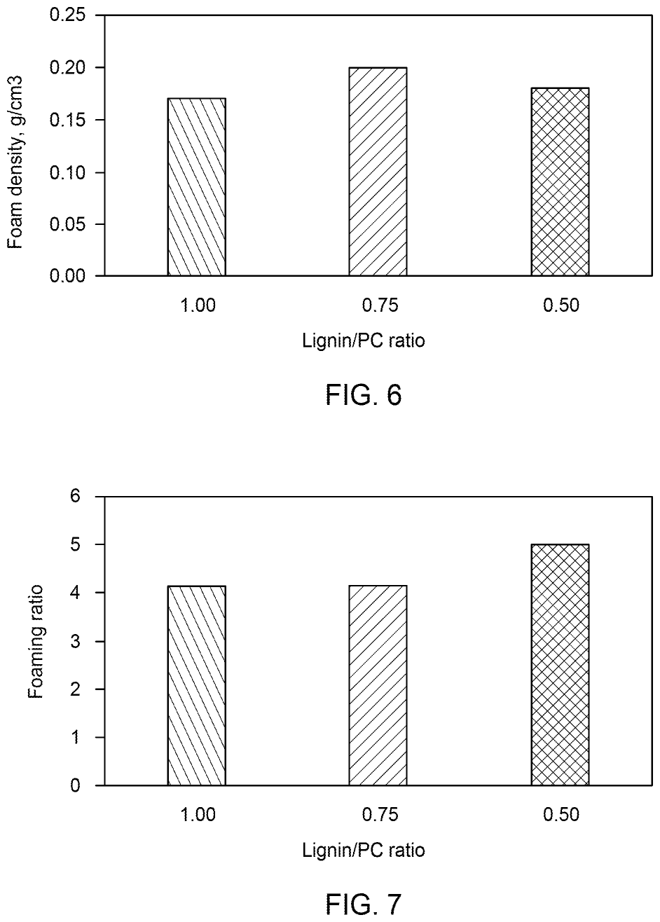

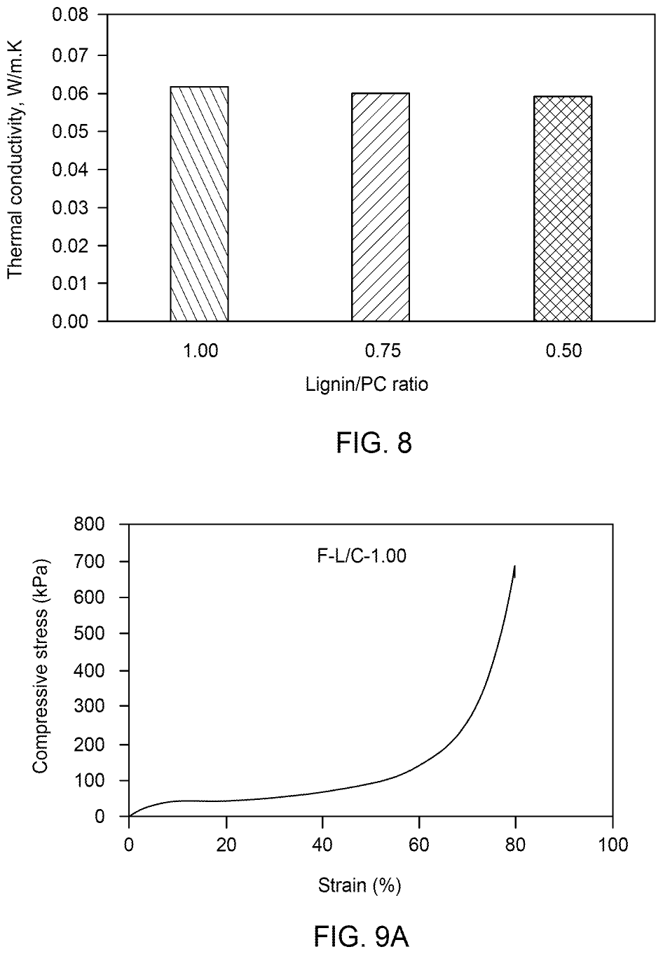

Table 4 shows a summary of the material testing results for varying lignin to PC ratios. FIG. 6 is a graph illustrating the CBF density versus lignin/PC ratio. FIG. 7 is a graph illustrating the foaming ratio versus lignin/PC ratio. FIG. 8 is a graph illustrating the thermal conductivity versus lignin/PC ratio.

TABLE 4
Test Results for Different Lignin/PC Ratios.

| | | | | Percent | Thermal | Permanent |
|---|---|---|---|---|---|---|
| | Lignin/PC | Density | Foaming | void | conductivity | deformation |
| CBF Name | ratio | (g/cm³) | ratio | (%) | (W/m · K) | (%) |
| F-L/C-1.00 | 1.00 | 0.17 | 4.16 | 75.94 | 0.0618 | 7.47 |
| F-L/C-0.75 | 0.75 | 0.20 | 4.16 | 75.96 | 0.0602 | 22.99 |
| F-L/C-0.50 | 0.50 | 0.18 | 4.99 | 79.97 | 0.0592 | 51.80 |

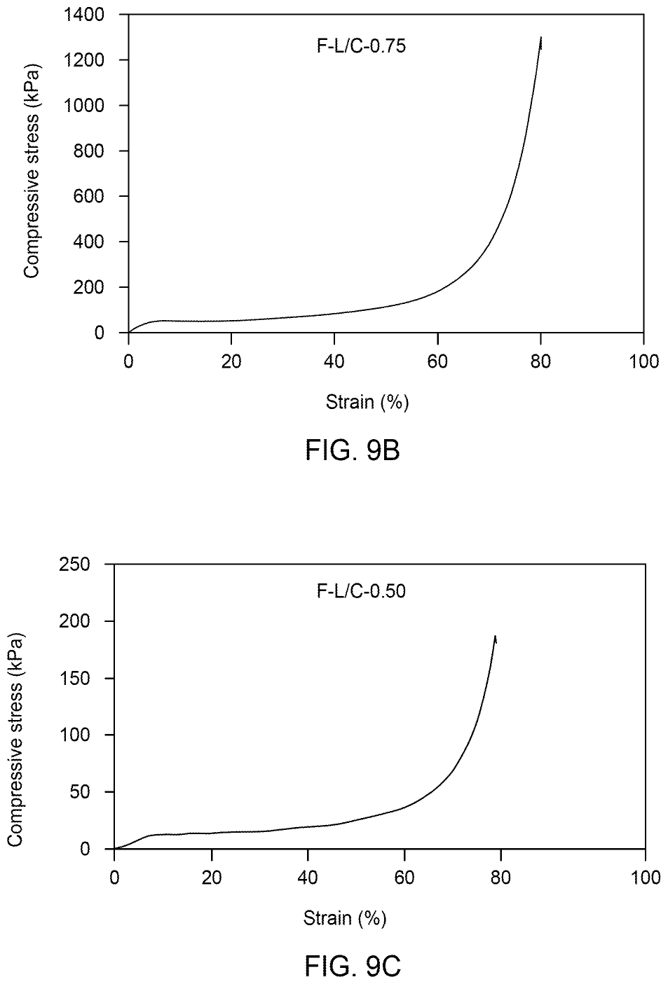

FIG. 9A is a graph illustrating the compressive stress versus strain diagram for the F-L/C-1.00 CBF sample. FIG. 9B is a graph illustrating the compressive stress versus strain diagram for the F-L/C-0.75 CBF sample. FIG. 9C is a graph illustrating the compressive stress versus strain diagram for the F-L/C-0.50 CBF sample. The F-L/C-1.00 sample has the lowest density, lowest permanent deformation, and least amount of loose PC particle on the CBF surface. The F-L/C-0.50 CBF sample has the lowest thermal conductivity, which may be due to comparatively weaker bonding. A higher foaming ratio may be obtained for a lower lignin/PC ratios. Compressive strength is reduced to about 235 kPa for F-L/C-0.50 compared to about 685 kPa for F-L/C-1.00 and about 1300 kPa for F-L/C-0.75, respectively. The lignin/PC ratio of 1.00 has the lowest density, lowest permanent deformation, and least loose PC particles on CBF surface.

Table 5 shows material quantities for different foaming agent to solvent (e.g., pMDI/(water+PEG)) ratios. The CBF samples include a CBF sample having a foaming agent to solvent ratio of about 1.00 (F-FA/Sol-1.00), a CBF sample having a foaming agent to solvent ratio of about 0.75 (F-FA/Sol-0.75), and a CBF sample having a foaming agent to solvent ratio of about 0.50 (F-FA/Sol-0.50). A PC content of about 10% is maintained. The particle size of the PC powder is about 150 μm. The materials quantities of the lignin/PC ratio is about 1.00, the water/PEG is about 0.67, the TA/(water+PEG+pMDI) ratio is about 0.005, and a gross material quantity of about 0.08% DD is kept constant. After curing, the F-FA/Sol-1.00 was difficult to cut with a knife to make into smaller pieces for testing. Thus, the F-FA/Sol-1.00 CBF sample may cause sudden breaks during handling and construction. The F-FA/Sol-0.50 CBF had a loose and damp surface due to the excess solvent present in the CBF, even after foaming.

TABLE 5
Material Quantities for Different Foaming Agent/Solvent Ratios.

| | PC | Ligning | Water | PEG | pMDI | Surfactant | Catalyst | Total |
|---|---|---|---|---|---|---|---|---|
| CBF Name | (g) | (g) | (g | (g) | (g) | (g) | (g) | (g) |
| F-FA/Sol-1.00 | 8.5 | 8.5 | 16.91 | 25.25 | 42.16 | 0.422 | 0.084 | 101.83 |
| F-FA/Sol-0.75 | 8.5 | 8.5 | 19.88 | 29.67 | 38.25 | 0.425 | 0.085 | 105.32 |
| F-FA/Sol-0.50 | 8.5 | 8.5 | 24.59 | 36.7 | 30.64 | 0.46 | 0.9 | 109.48 |

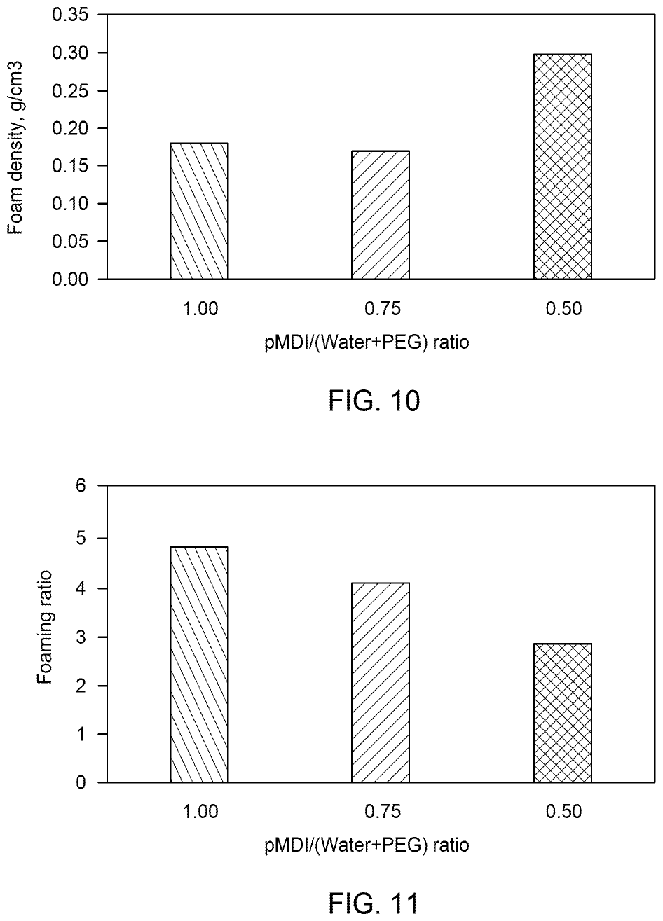

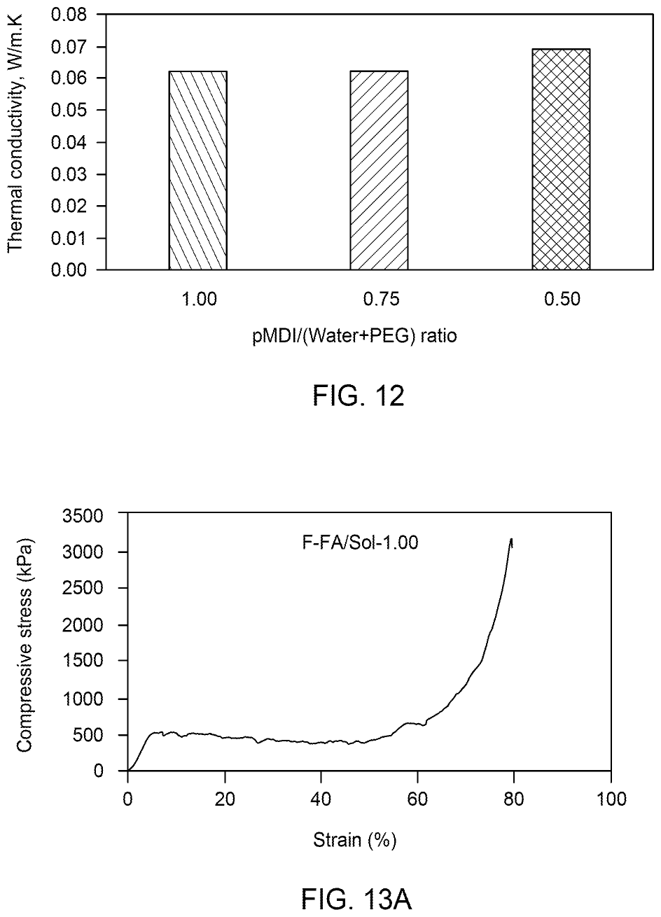

Table 6 illustrates a summary of the test results for different foaming agent/solvent ratios. FIG. 10 is a graph illustrating the foam density versus solvent ratio. FIG. 11 is a graph illustrating the foaming ratio versus solvent ratio. FIG. 12 is a graph illustrating the thermal conductivity versus solvent ratio.

TABLE 6
Test Results for Different Foaming Agent/Solvent Ratios.

| | pMDI/ | | | Percent | Thermal | Permanent |
|---|---|---|---|---|---|---|
| | (PEG + | Density | Foaming | void | conductivity | deformation, |
| CBF Name | water) | (g/cm³) | ratio | (%) | (W/m · K) | (%) |
| F-FA/Sol-1.00 | 1.00 | 0.18 | 4.93 | 79.73 | 0.0619 | 67.62 |
| F-FA/Sol-0.75 | 0.75 | 0.17 | 4.16 | 75.94 | 0.0618 | 7.47 |
| F-FA/Sol-0.50 | 0.50 | 0.30 | 2.87 | 65.12 | 0.0692 | 62.28 |

A decrease in the foaming agent/solvent ratio may increase the density of the CBF sample. The F-FA/Sol-1.00 and F-FA/Sol-0.75 have similar densities of 0.18 g/cm³ and 0.17 g/cm³, respectively, whereas F-FA/Sol-0.50 has a higher density of 0.30 g/cm³ for. A trend similar to the density trend occurs for thermal conductivity, with similar thermal conductivity for the ratio of F-FA/Sol-1.00 and F-FA/Sol-0.75 but higher thermal conductivity for the ratio of F-FA/Sol-0.50. An increase in the foaming agent/solvent ratio may increase the foaming ratio.

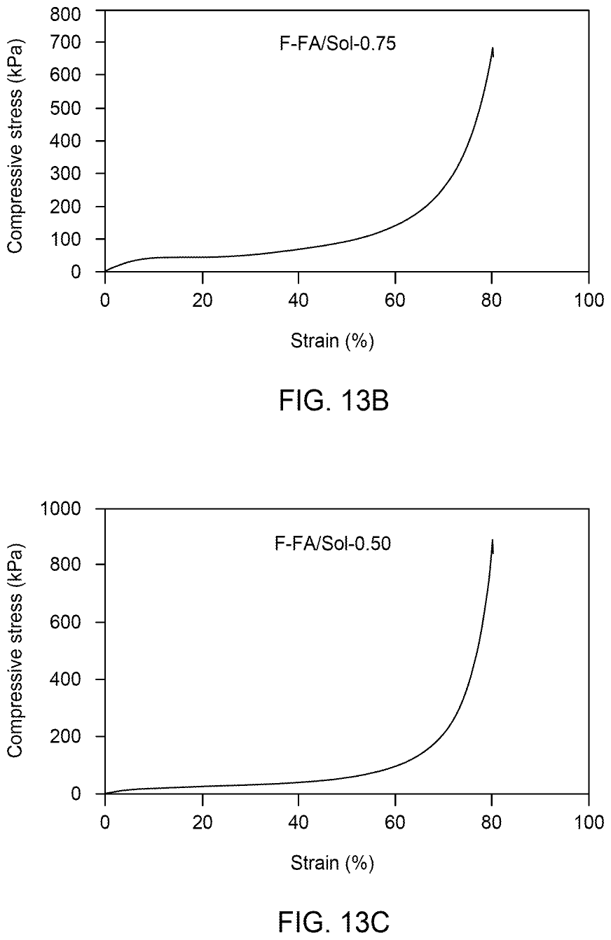

FIG. 13A is a graph illustrating the compressive stress versus strain diagram for the F-FA/Sol-1.00 CBF sample. FIG. 13B is a graph illustrating the compressive stress versus strain diagram for the F-FA/Sol-0.75 CBF sample. FIG. 13C is a graph illustrating the compressive stress versus strain diagram for the F-FA/Sol-0.50 CBF sample. The F-FA/Sol-1.00 may have less ductility up to an initial 500 kPa, which can cause breaking during installation.

Table 7 shows the material quantities of CBF samples with varying water/PEG ratios. The CBF samples include a CBF sample having a water/PEG ratio of about 0.75 (F-W/PEG-0.75), a CBF sample having a water/PEG ratio of about 0.67 (F-W/PEG-0.67), and a CBF sample having a water/PEG ratio of about 0.50 (F-W/PEG-0.50). The CBF samples include 10% PC content. The PC had a maximum particle size of about 150 μm. The mixing parameters are kept the same for all three CBF samples, with a lignin/PC ratio of about 1.00, a pMDI/(water+PEG) ratio of about 0.75, a TA/(water+PEG+pMDI) ratio of about 0.005, and a gross material quantity of about 0.08% DD.

TABLE 7
Material Quantities for Different Water/PEG Ratios.

| | PC | Lignin | Water | PEG | pMDI | Surfactant | Catalyst | Total |
|---|---|---|---|---|---|---|---|---|
| CBF Name | (g) | (g) | (g) | (g) | (g) | (g) | (g) | (g) |
| F-W/PEG-0.75 | 8.5 | 8.5 | 21.86 | 29.14 | 38.25 | 0.446 | 0.088 | 106.78 |
| F-W/PEG-0.67 | 8.5 | 8.5 | 19.88 | 29.67 | 38.25 | 0.425 | 0.085 | 105.32 |
| F-W/PEG-0.50 | 8.5 | 8.5 | 15.87 | 31.73 | 35.7 | 0.417 | 0.083 | 100.8 |

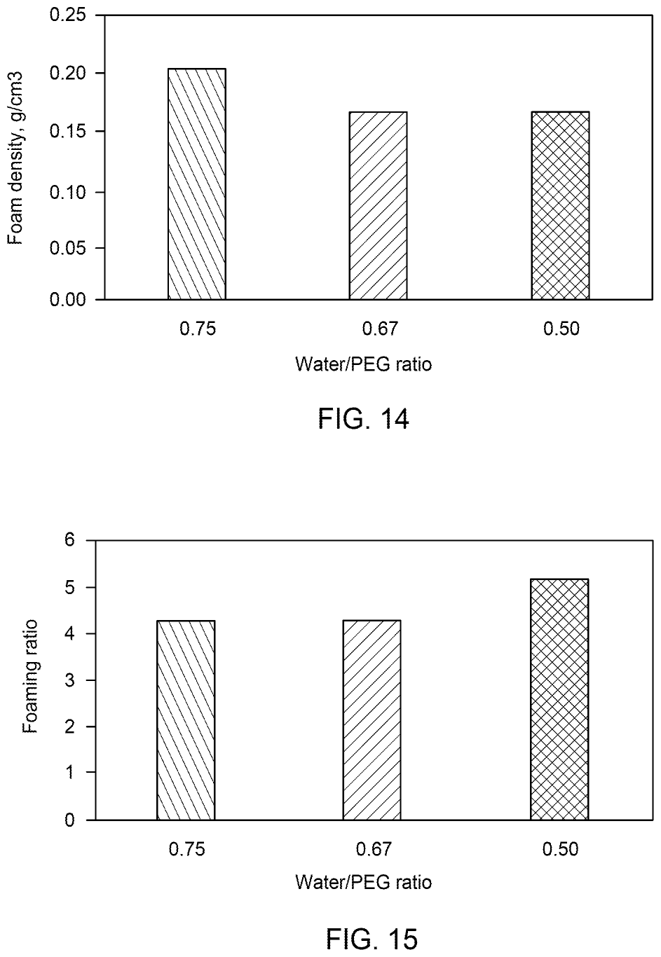

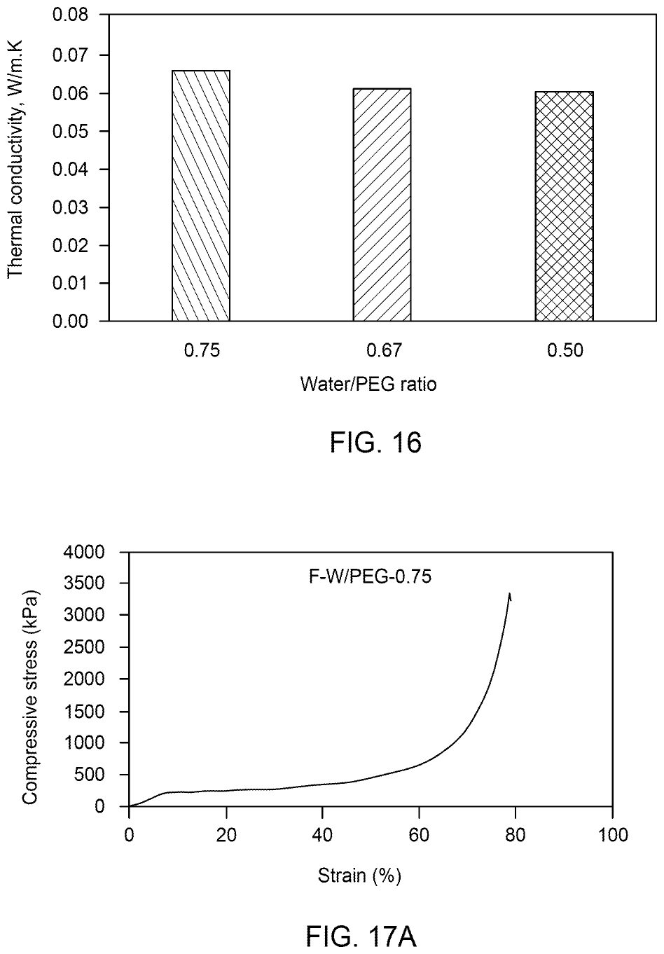

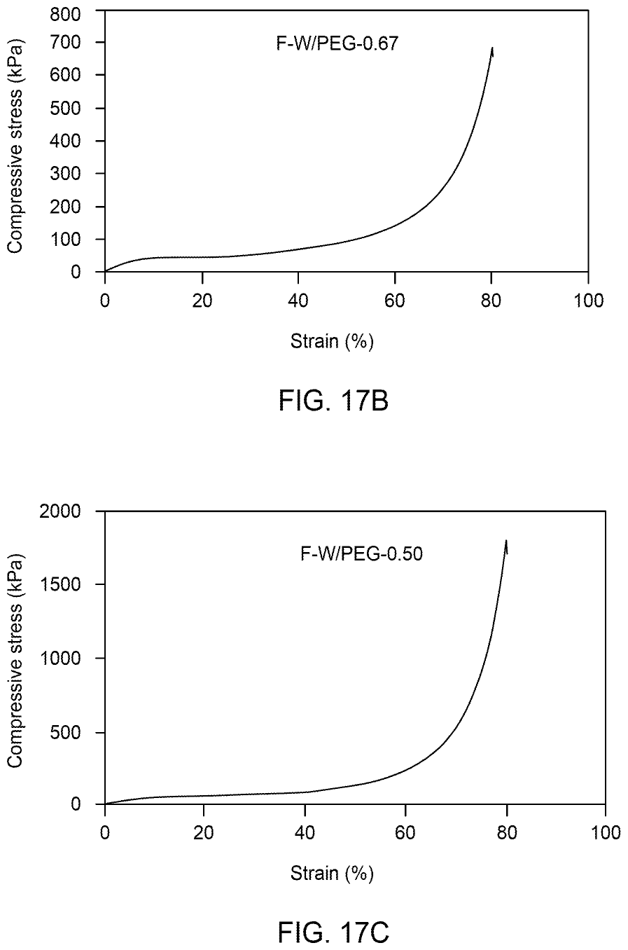

Table 8 summarizes the test results for different water/PEG ratios. FIG. 14 is a graph illustrating the foam density versus water/PEG ratio. FIG. 15 is a graph illustrating foaming ratio versus water/PEG ratio. FIG. 16 is a graph illustrating the thermal conductivity versus water/PEG ratio. FIG. 17A is a graph illustrating the compressive stress versus strain for the F-W/PEG-0.75 CBF sample. FIG. 17B is a graph illustrating the compressive stress versus strain for the F-W/PEG-0.67 CBF sample. FIG. 17C is a graph illustrating the compressive stress versus strain for the F-W/PEG-0.50 CBF sample.

F-W/PEG-0.67 CBF sample and F-W/PEG-0.50 CBF sample have a density of about 0.17 g/cm³, while the density for F-W/PEG-0.75 increased to about 0.21 g/cm³. Foaming ratio may increase with the decrease of the water/PEG ratio. Thermal conductivity may decrease with the decrease of the water/PEG ratio. The F-W/PEG-0.75 CBF sample has higher thermal conductivity than the F-W/PEG-0.67 CBF sample and F-W/PEG-0.50 CBF sample. F-W/PEG-0.50 has slightly lower thermal conductivity (about 0.0615 W/m·K) than for F-W/PEG-0.67 (about 0.0618 w/m·K).

TABLE 8
Test Results for Different Water/PEG Ratios.

| | | | | Percent | Thermal | Permanent |
|---|---|---|---|---|---|---|
| | Water/PEG | Density | Foaming | void | conductivity | deformation, |
| CBF Name | ratio | (g/cm³) | ratio | (%) | (W/m · K) | (%) |
| F-W/PEG-0.75 | 0.75 | 0.21 | 3.88 | 74.21 | 0.0666 | 37.95 |
| F-W/PEG-0.67 | 0.67 | 0.17 | 4.16 | 75.94 | 0.0618 | 7.47 |
| F-W/PEG-0.50 | 0.50 | 0.17 | 5.03 | 80.12 | 0.0615 | 6.94 |

Table 9 shows material quantities for different surfactant/(water+PEG+pMDI) ratios of 0.0075 (F-S-0.0075), 0.0050 (F-S-0.0050), and 0.0025 (F-S-0.0025). Surfactant may reduce the surface tension of the mixture, enabling a better foaming ratio with lower thermal conductivity. PC content and particle size may be maintained at about 10% and 150 μm particle size. The mixing parameters may be maintained at a lignin/PC ratio of about 1.00, a pMDI/(water+PEG) ratio of about 0.67, and a gross material quantity of about 0.08% DD.

TABLE 9
Material Quantities for Different Surfactant/(Water + PEG + pMDI) Ratios.

| | PC | Lignin | Water | PEG | pMDI | Surfactant | Catalyst | Total |
|---|---|---|---|---|---|---|---|---|
| CBF Name | (g) | (g) | (g) | (g) | (g) | (g) | (g) | (g) |
| F-S-0.0075 | 8.5 | 8.5 | 19.98 | 29.83 | 37.36 | 0.654 | 0.086 | 104.91 |
| F-S-0.0050 | 8.5 | 8.5 | 19.88 | 29.67 | 38.25 | 0.425 | 0.085 | 105.32 |
| F-S-0.0025 | 8.5 | 8.5 | 20.12 | 30.03 | 37.61 | 0.219 | 0.087 | 105.07 |

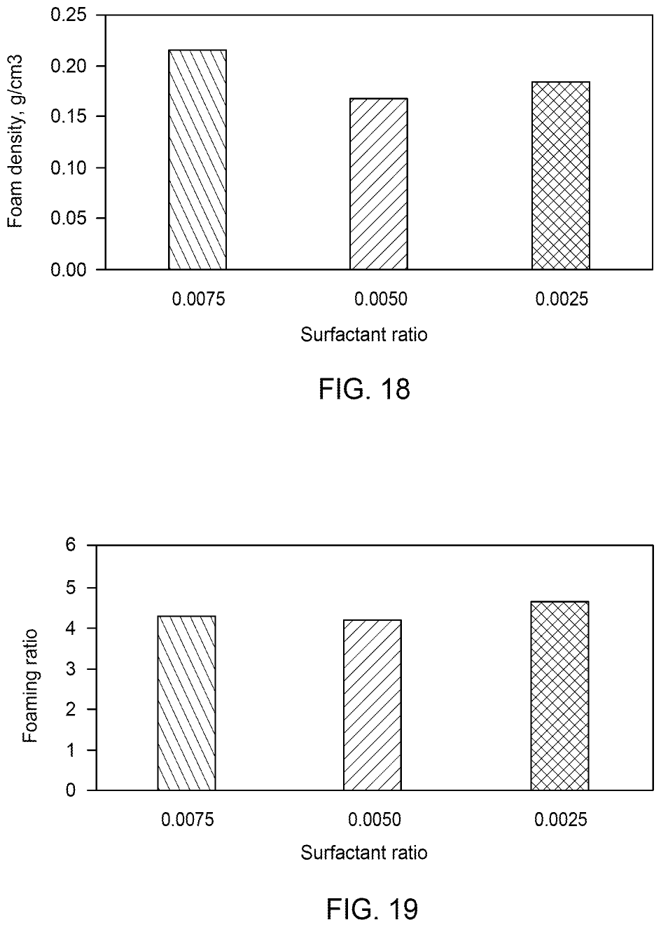

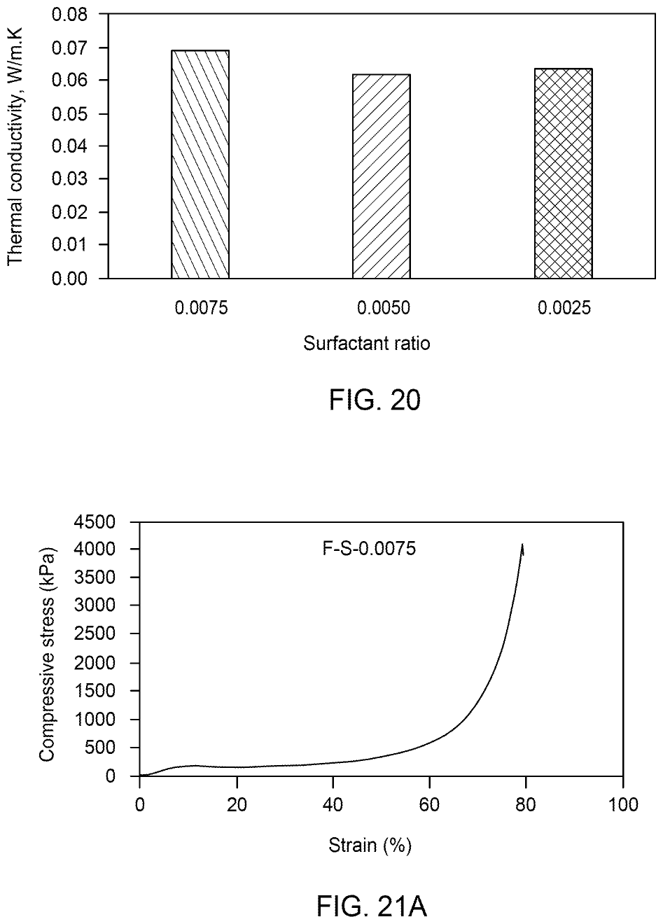

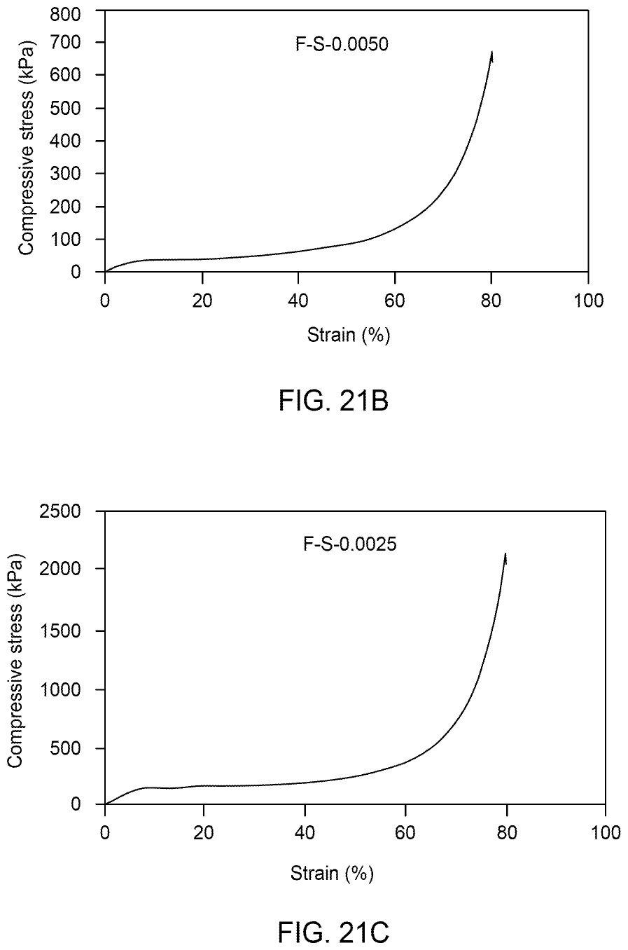

Table 10 summarizes the test results for different surfactant/(water+PEG+pMDI) ratios. FIG. 18 is a graph illustrating the foam density versus surfactant ratio. FIG. 19 is a graph illustrating the foaming ratio versus surfactant ratio. FIG. 20 is a graph illustrating thermal conductivity versus surfactant ratio. FIG. 21A is a graph illustrating the compressive stress versus strain diagram for a F-S-0.0075 CBF sample. FIG. 21B is a graph illustrating the compressive stress versus strain diagram for a F-S-0.0050 CBF sample. FIG. 21C is a graph illustrating the compressive stress versus strain diagram for a F-S-0.0025 CBF sample. Density and thermal conductivity may decrease as the surfactant ratio decreases. The lowest density and thermal conductivity are found for the F-S-0.0050 sample.

TABLE 10
Test Results for Different Surfactant/(Water + PEG + pMDI) Ratios.

| | Surfactant | | | | Thermal | Permanent |
|---|---|---|---|---|---|---|
| | TA/ (water + | Density | Foaming | Percent | conductivity | deformation |
| CBF Name | PEG + pMDI) | (g/cm³) | ratio | void (%) | (W/m · K) | (%) |
| F-S-0.0075 | 0.0075 | 0.22 | 4.27 | 76.59 | 0.0691 | 13.03 |
| F-S-0.0050 | 0.0050 | 0.17 | 4.16 | 75.94 | 0.0618 | 7.47 |
| F-S-0.0025 | 0.0025 | 0.19 | 4.61 | 78.30 | 0.0632 | 15.00 |

Table 11 shows material quantities for different surfactants of triethylene amine (F-TA) and silicon oil (F-SO). Surfactants reduce the surface tension of the mixtures before foaming. The mixing parameters are kept the same for the two samples with a lignin/PC ratio of about 1.00, a pMDI/(water+PEG) ratio of about 0.67, and a gross material quantity of about 0.08% DD. For both samples a surfactant/(water+PEG+pMDI) ratio of 0.0050 is maintained for CBF preparation.

TABLE 11
Material Quantities for Different Surfactants.

| CBF | PC | Lignin | Water | PEG | pMDI | Surfactant | Catalyst | Total |
|---|---|---|---|---|---|---|---|---|
| Name | (g) | (g) | (g) | (g) | (g) | (g) | (g) | (g) |
| F-TA | 8.5 | 8.5 | 19.88 | 29.67 | 38.25 | 0.425 | 0.085 | 105.32 |
| F-SO | 8.5 | 8.5 | 20.05 | 29.93 | 37.49 | 0.437 | 0.087 | 104.99 |

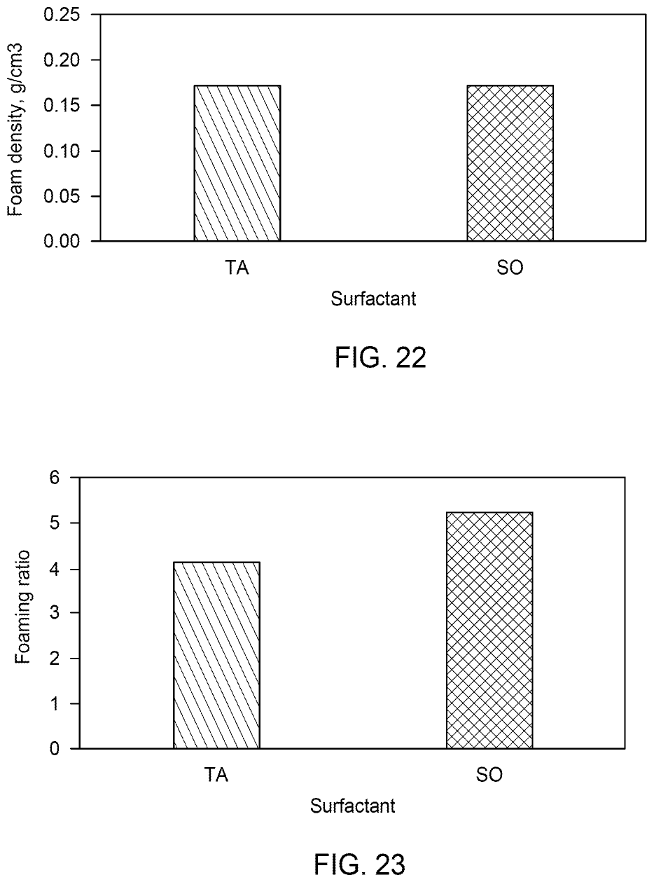

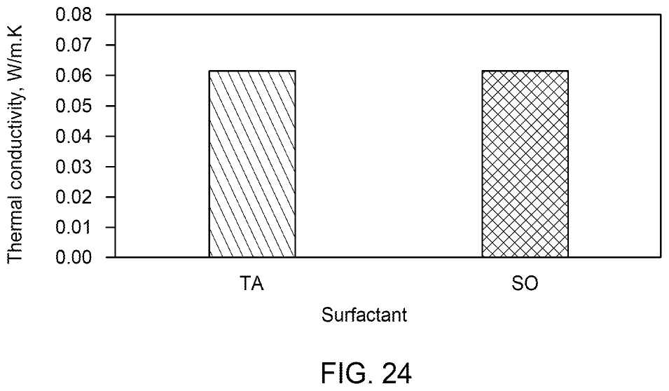

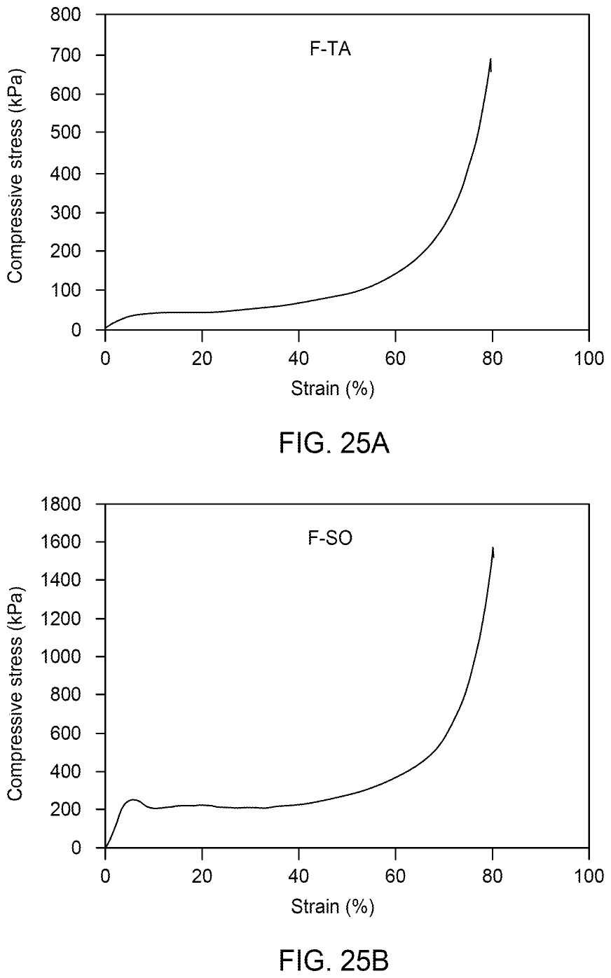

Table 12 shows a summary of test results for different surfactants. FIG. 22 is a graph illustrating foam density versus surfactant. FIG. 23 is a graph illustrating foaming ratio versus surfactant. FIG. 24 is a graph illustrating thermal conductivity versus surfactant. FIG. 25A is a graph illustrating the compressive stress versus strain diagram for a F-TA CBF sample. FIG. 25B is a graph illustrating the compressive stress versus strain diagram for a F-SO CBF sample. Both the F-TA and F-SO CBF samples have a density of about 0.17 g/cm³. The F-SO CBF sample had a higher foaming ratio and a slightly lower thermal conductivity than the F-TA CBF sample.

TABLE 12
Test Results for Different Surfactants.

| | | | | Percent | Thermal | Permanent |
|---|---|---|---|---|---|---|
| | | Density | Foaming | void | conductivity | deformation |
| CBF Name | Surfactant | (g/cm³) | ratio | (%) | (W/m · K) | (%) |
| F-TA | TA | 0.17 | 4.16 | 75.94 | 0.0618 | 7.47 |
| F-SO | SO | 0.17 | 5.25 | 80.95 | 0.0617 | 16.20 |

Table 13 shows the material quantities for CBF samples with different PC contents. The CBF samples include a CBF sample having 5% PC (F-PC-5), a CBF sample having 10% PC (F-PC-10), a CBF sample having 12.5% PC (F-PC-12.5), a CBF sample having 15% PC (F-PC-15), and a CBF sample having 20% PC (F-PC-20). The PC content optimizes insulation properties. The mixing parameters are kept the same for all the five samples with a lignin/PC ratio of 1.00 (2.00 for 5%), pMDI/(water+PEG) ratio of about 0.75, water/PEG ratio of about 0.67, SO/(water+PEG+pMDI) ratio of about 0.005, and a gross material quantity of about 0.08% DD. A PC particle size of 150 μm is maintained.

TABLE 13
Material Quantities for Different PC Content.

| CBF | Char | Lignin | Water | PEG | pMDI | Surfactant | Catalyst | Total |
|---|---|---|---|---|---|---|---|---|
| name | (g) | (g) | (g) | (g) | (g) | (g) | (g) | (g) |
| F-PC-5 | 2.0 | 4.0 | 4.5 | 13.5 | 18 | 0.200 | 0.040 | 42.24 |
| F-PC-10 | 8.5 | 8.5 | 19.88 | 29.67 | 38.25 | 0.425 | 0.085 | 105.32 |
| F-PC-12.5 | 11 | 11 | 19.51 | 29.11 | 36.47 | 0.425 | 0.089 | 107.60 |
| F-PC-15 | 13 | 13 | 17.94 | 26.78 | 33.54 | 0.391 | 0.087 | 104.74 |
| F-PC-20 | 18 | 18 | 15.96 | 23.82 | 29.84 | 0.348 | 0.088 | 106.05 |

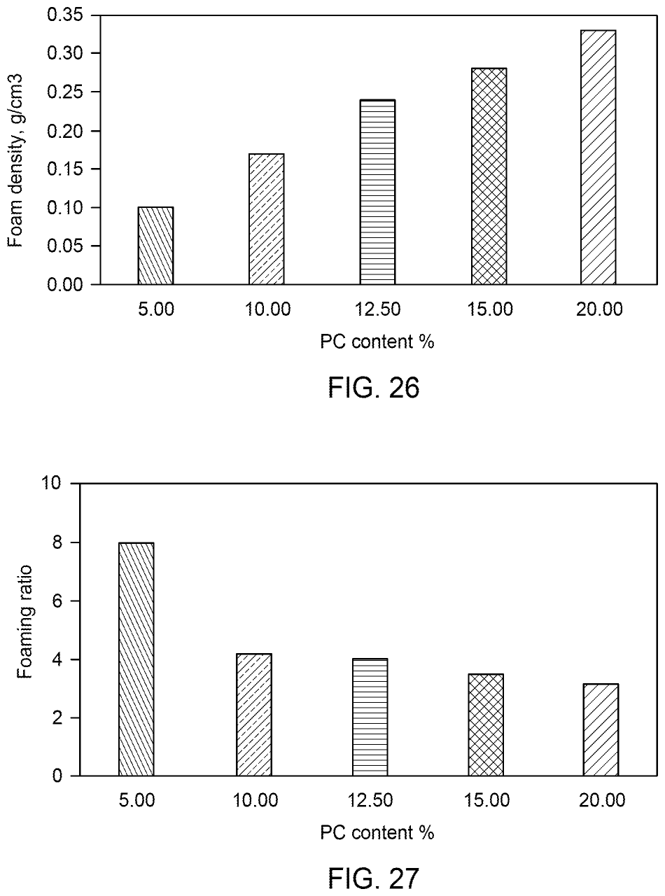

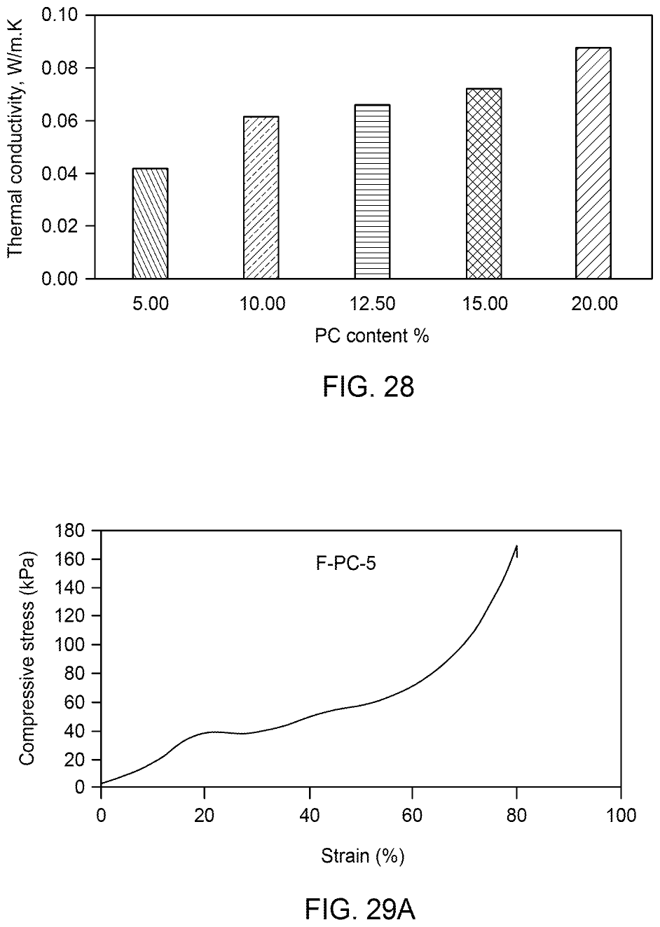

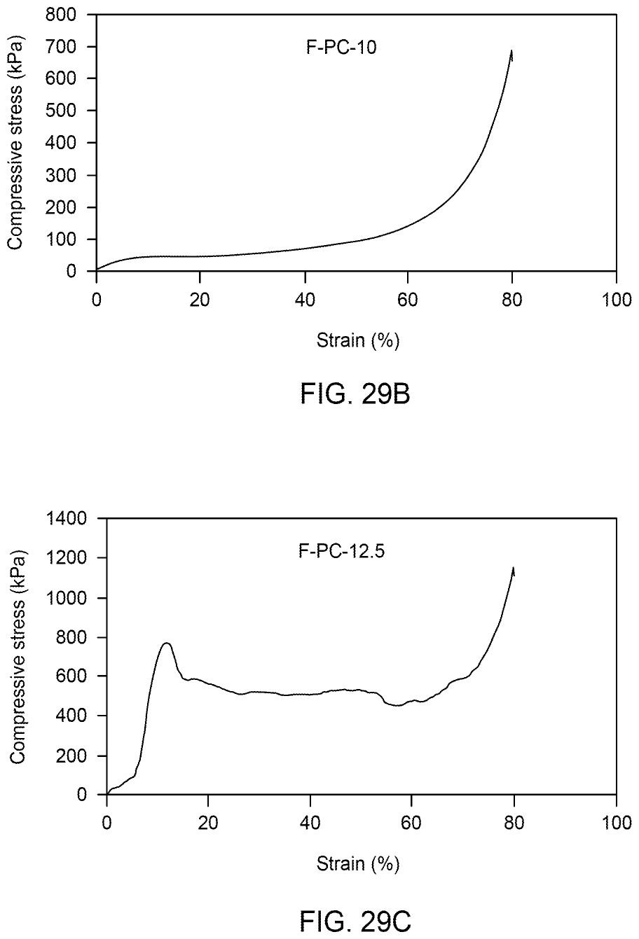

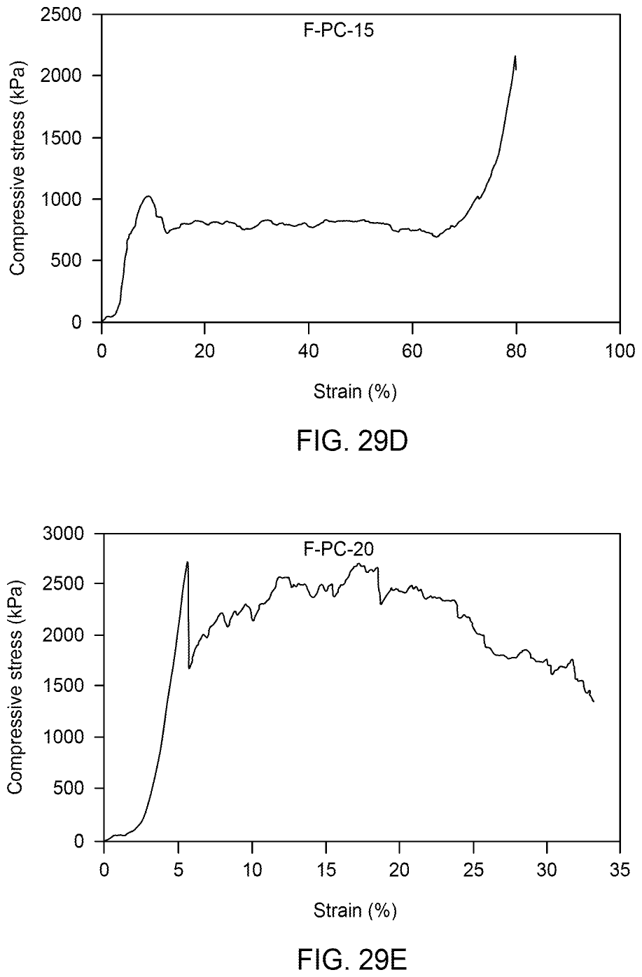

Table 14 shows the test results for different PC content samples. FIG. 26 is a graph illustrating the foam density versus PC content. FIG. 27 is a graph illustrating the foaming ratio versus PC content. FIG. 28 is a graph illustrating the thermal conductivity versus PC content. FIG. 29A is a graph illustrating the compressive stress versus strain diagram for the F-PC-5 CBF sample. FIG. 29B is a graph illustrating the compressive stress versus strain diagram for the F-PC-10 CBF sample. FIG. 29C is a graph illustrating the compressive stress versus strain diagram for the F-PC-12.5 CBF sample. FIG. 29D is a graph illustrating the compressive stress versus strain diagram for the F-PC-15 CBF sample. FIG. 29E is a graph illustrating the compressive stress versus strain diagram for the F-PC-20 CBF sample. The foam density and thermal conductivity may increase with the increase of PC content. The foaming ratio may decreases with the increase of PC content because the additional PC replaces other chemicals such as PEG and pMDI in the mixture, which is mainly responsible for the foaming reaction. The stress-strain curves may indicate that the compressive strength increases with the increase of PC content, which may also be responsible for a corresponding increase in permanent deformation and CBF toughness. When the PC content is increased to >12.5%, the CBF samples may lose ductility and behave like rigid material (e.g., less deflection) with applied stress.

TABLE 14
Test Results for Different PC Content

| | | | | Percent | Thermal | Permanent |
|---|---|---|---|---|---|---|
| | PC | Density, | Foaming | void | conductivity | deformation, |
| CBF Name | content | g/cm³ | ratio | (%) | (W/m · K) | % |
| F-PC-5 | 5.00 | 0.10 | 7.98 | 87.47 | 0.0421 | 2.24 |
| F-PC-10 | 10.00 | 0.17 | 4.16 | 75.94 | 0.0618 | 7.47 |
| F-PC-12.5 | 12.50 | 0.24 | 4.07 | 75.41 | 0.0664 | 25.82 |
| F-PC-15 | 15.00 | 0.28 | 3.47 | 71.15 | 0.0720 | 42.26 |
| F-PC-20 | 20.00 | 0.33 | 3.14 | 68.19 | 0.0873 | Fracture |

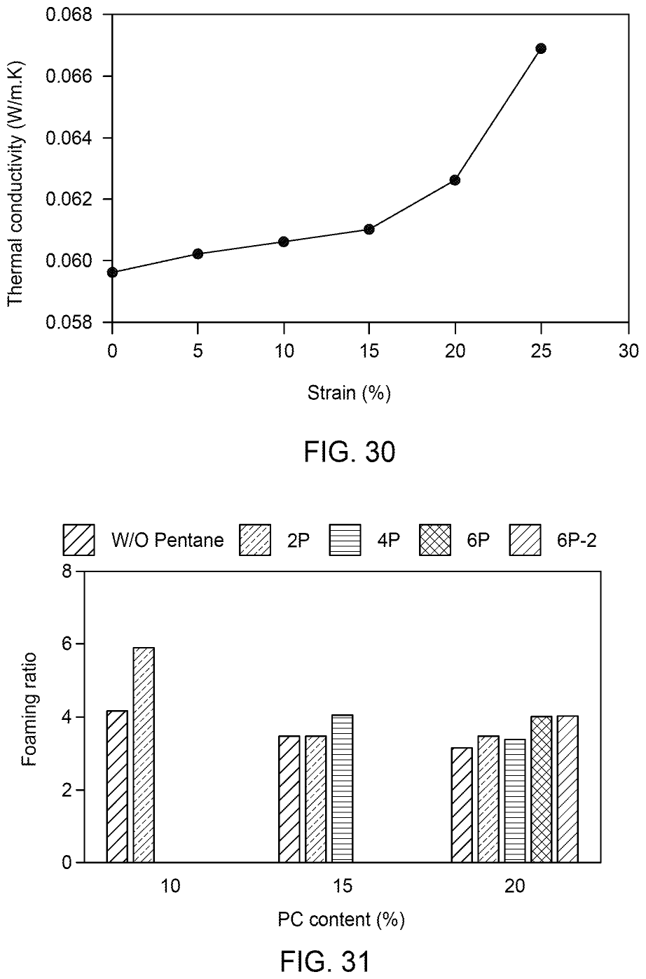

FIG. 30 is a graph illustrating the thermal conductivity versus strain of CBF. During the installation of the CBF, the CBF may be deformed and cause an increase in thermal conductivity due to compaction. For this reason change of thermal conductivity with percent deformation (e.g., strain is tested up to 25% deformation) for a CBF sample is tested. The CBF sample is prepared with 10% PC content with the mixing parameters kept at a lignin/PC ratio of 1.00 (2.00 for 5%), pMDI/(water+PEG) ratio of about 0.75, water/PEG ratio of about 0.67, SO/(water+PEG+pMDI) ratio of about 0.005, and a gross material quantity of about 0.08% DD. A PC particle size of 150 μm is maintained. Up to 15% strain, the thermal conductivity increases slowly and linearly from 0.0596 W/m·K to 0.0610 W/m·K, about a 2.3% increase. With further increase of strain, the thermal conductivity increased to 0.0626 W/m·K for 20% strain and 0.0669 W/m·K for 25% strain. Usually, the CBF deformation during installation is not more than 10%, which means the test results show this CBF can be installed with more deformation, up to 15%, without compromising thermal insulation capacity.

Table 15 is a summary of the test results of the CBF samples with and without pentane. The CBF samples include a CBF sample having 0% pentane and 10% PC (F-10), 0% pentane and 15% PC (F-15), 0% pentane and 20% PC (F-20), 2% pentane and 10% PC (F-10-2P), a CBF sample having 2% pentane and 15% PC (F-15-2P), a CBF sample having 2% pentane and 20% PC (F-20-2P), a CBF sample having 4% pentane and 10% PC (F-10-4P), a CBF sample having 4% pentane and 15% PC (F-15-4P), a CBF sample having 4% pentane and 20% PC (F-20-4P), a CBF sample having 6% pentane and 10% PC (F-10-6P), a CBF sample having 6% pentane and 15% PC (F-15-6P), a CBF sample having 6% pentane and 20% PC (F-20-6P). PC with a maximum particle size of 150 μm is used for the CBF samples. One CBF sample includes 600 μm PC and 6% pentane (F-20-6P-2). The mixing parameters are kept the CBF samples with a lignin/char ratio of 1.00, pMDI/(water+PEG) ratio of 0.75, water/PEG ratio of 0.67, SO/(water+PEG+pMDI) ratio of 0.005, 0.08% DD of gross material quantity.

TABLE 15
Summary of Test Results of the CBF Samples With and Without Pentane.

| | Mixture | Foam | | Percent | | | Thermal |
|---|---|---|---|---|---|---|---|
| CBF | Volume | Volume | Foaming | void | Weight | Density | conductivity |
| Name | (cm³) | (cm³) | ratio | (%) | (g) | (g/cm³) | (W/m · K) |
| F-10 | 83.04 | 345.18 | 4.16 | 75.94 | 57.07 | 0.17 | 0.0618 |
| F-10-2P | 101.35 | 598.86 | 5.91 | 83.08 | 94.62 | 0.16 | 0.0612 |
| F-15 | 86.87 | 301.17 | 3.47 | 71.15 | 83.75 | 0.28 | 0.0720 |
| F-15-2P | 86.87 | 301.17 | 3.47 | 71.15 | 79.89 | 0.27 | 0.7020 |
| F-15-4P | 86.87 | 350.97 | 4.04 | 75.25 | 80.3 | 0.23 | 0.0667 |
| F-20 | 82.89 | 260.62 | 3.14 | 68.19 | 84.75 | 0.33 | 0.0873 |
| F-20-2P | 86.87 | 301.17 | 3.47 | 71.15 | 80.34 | 0.24 | 0.0805 |
| F-20-4P | 86.87 | 315.07 | 3.63 | 72.43 | 82.27 | 0.26 | 0.0857 |
| F-20-6P | 86.87 | 346.34 | 3.99 | 74.92 | 82.72 | 0.24 | 0.0821 |
| F-20-6P-2 | 86.87 | 348.66 | 4.01 | 75.08 | 81.9 | 0.23 | 0.0666 |

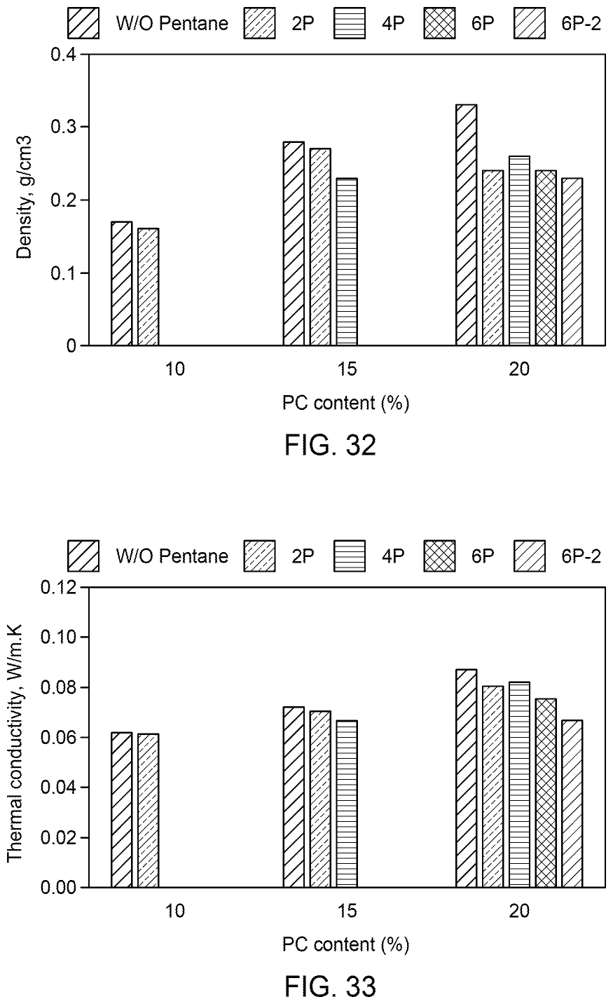

FIG. 31 is a graph illustrating the foaming ratio versus pentane content. FIG. 32 is a graph illustrating the foam density versus pentane content. FIG. 33 is a graph illustrating the thermal conductivity versus pentane content. The foaming ratio increases from 4.16 for the F-10 CBF sample to 5.91 for a F-10-2P CBF samples. The foaming ratio, however, does not change between F-15 and F-15-2P (3.47) samples, but increases to 4.04 for F-15-4P CBF sample. For the F-20 CBF samples, the foaming ratio increases with the increase of pentane content. The density decreases by about 6% from the F-10 CBF sample to F-10-2P CBF sample, 3.5% from the F-15 CBF sample to the F-15-2P CBF sample, and 27% from the F-20 CBF sample to the F-20-2P CBF sample. The density may continue to decrease with further addition of pentane. The thermal conductivity may decrease with the addition of pentane in varying quantities for all samples. The thermal conductivity decreases from 0.873 W/m·K for the F-20 CBF sample to 0.0.821 W/m·k for the F-20-6P CBF sample. The thermal condictivity further decreases to 0.666 W/m·K when the PC size increases to a maximum of 600 μm.

### Embodiments Listing

The present disclosure provides, among other things, the following embodiments, each of which can be considered as optionally including any alternate embodiment.

Clause 1. A composition, comprising:
about 5% to about 20% pyrolysis char (PC) by weight;
about 80% to about 95% lignin solution by weight, wherein the lignin solution comprises:
   a lignin; and
   a solvent.

Clause 2. The composition of clause 1, wherein the solvent comprises:
water;
a polyol; and
a polyisocyanate.

Clause 3. The composition of clause 2, wherein the polyol comprises Poly Ethylene Glycol (PEG), diethylene glycol (DEG), polypropylene glycol (PEG), or a combination thereof.

Clause 4. The composition of clause 2, wherein the polyisocyanate comprises poly methyl diphenyl diisocyanate (pMDI), methylene diphenyl diisocyanate (monomeric MDI), or a combination thereof.

Clause 5. The composition of clause 2, wherein a polyisocyanate to water and polyol ratio is from about 0.5 to about 1.0 by weight.

Clause 6. The composition of clause 2, wherein a water to polyol ratio is from about 0.5 to about 0.75 by weight.

Clause 7. The composition of clause 1, wherein the lignin to PC ratio is from about 0.5 to about 1.0

Clause 8. The composition of clause 1, wherein the PC has a particle size may less than about 300 μm.

Clause 9. A carbon based foam (CBF), comprising:
a cured composition, the composition comprising:
   about 5% to about 20% pyrolysis char (PC) by weight;
   about 80% to about 95% lignin solution by weight, wherein the lignin solution comprises:
      a lignin; and
      a solvent.

Clause 10. The CBF of clause 9, wherein the solvent comprises:
water;
a polyol; and
a polyisocyanate.

Clause 11. The CBF of clause 10, wherein the polyol comprises Poly Ethylene Glycol (PEG), diethylene glycol (DEG), polypropylene glycol (PEG), or a combination thereof.

Clause 12. The CBF of clause 10, wherein the polyisocyanate comprises poly methyl diphenyl diisocyanate (pMDI), methylene diphenyl diisocyanate (monomeric MDI), or a combination thereof.

Clause 13. The CBF of clause 10, wherein a polyisocyanate to water and polyol ratio is from about 0.5 to about 1.0 by weight.

Clause 14. The CBF of clause 10, wherein a water to polyol ratio is from about 0.5 to about 0.75 by weight.

Clause 15. The CBF of clause 9, wherein the lignin to PC ratio is from about 0.5 to about 1.0.

Clause 16. The CBF of clause 9, wherein the PC has a particle size may less than about 300 μm.

Clause 17. The CBF of clause 9, wherein the CBF has a foam density of about 0.1 g/cm³ to about 0.33 g/cm³.

Clause 18. The CBF of clause 9, wherein the CBF has a foaming ratio of about 2.46 to about 7.98.

Clause 19. The CBF of clause 9, wherein the CBF has a thermal conductivity of about 0.0542 W/m·K to about 0.087 W/m·K.

Clause 20. The CBF of clause 9, wherein the CBF has a compression strength of about 200 kPa to about 5000 kPa.

Clause 21. A method of making a composition, comprising:
grinding and sieving a pyrolysis char (PC) to form a PC powder;
mixing a lignin with a solvent to form a lignin solution;
mixing the PC powder with the lignin solution to form a lignin-PC solution; mixing a surfactant and a catalyst with the lignin-PC solution to form a raw materials mixture;
mixing a foaming agent with the raw materials mixture to form a lignin-PC foam; and
curing the lignin-PC foam to form a carbon based foam (CBF).

Clause 22. The method of clause 21, wherein the lignin-PC foam comprises:
about 5% to about 20% pyrolysis char (PC) by weight;
about 80% to about 95% lignin solution by weight, wherein the lignin solution comprises:
   a lignin; and
   a solvent.

Clause 23. The method of clause 22, wherein the solvent comprises:
water;
a polyol; and
a polyisocyanate.

Clause 24. The method of clause 23, wherein the polyol comprises Poly Ethylene Glycol (PEG), diethylene glycol (DEG), polypropylene glycol (PEG), or a combination thereof.

Clause 25. The method of clause 23, wherein the polyisocyanate comprises poly methyl diphenyl diisocyanate (pMDI), methylene diphenyl diisocyanate (monomeric MDI), or a combination thereof.

Clause 26. The method of clause 23, wherein a polyisocyanate to water and polyol ratio is from about 0.5 to about 1.00 by weight.

Clause 27. The method of clause 23, wherein a water to polyol ratio is from about 0.5 to about 0.75 by weight.

Clause 28. The method of clause 21, wherein the lignin to PC ratio is from about 0.5 to about 1.00.

Clause 29. The method of clause 21, wherein the PC has a particle size may less than about 300 μm.

Clause 30. The method of clause 21, wherein the CBF has a foam density of about 0.1 g/cm³ to about 0.33 g/cm³.

Clause 31. The method of clause 21, wherein the CBF has a foaming ratio of about 2.46 to about 7.98.

Clause 32. The method of clause 21, wherein the CBF has a thermal conductivity of about 0.042 W/m·K to about 0.087 W/m·K.

Clause 33. The method of clause 21, wherein the CBF has a compression strength of about 200 kPa to about 5000 kPa.

Clause 34. The method of clauses 21-33, further comprising:
stirring the lignin solution for about 1 minutes to about 5 minutes.

Clause 35. The method of clauses 34, further comprising:
heating the lignin solution after stirring the lignin solution at about 50° C. to about 100° C. for about 5 minutes to about 20 minutes; and
stirring the lignin solution for about 1 minutes to about 3 minutes.

Clause 36. The method of clauses 21-33, wherein the mixing of the PC powder and lignin solution is at room temperature.

Clause 37. The method of clauses 21-33, wherein the surfactant comprises triethylene amine (TA), silicon oil (SO), or a combination thereof.

Clause 38. The method of clauses 37, wherein the surfactant to water, polyol and polyisocyanate ratio is from about 0.0025 to about 0.0075 by weight.

Clause 39. The method of clauses 21-33, wherein the catalyst comprises dibutyltin dilaurate (DD), stannous octoate, or a combination thereof.

Clause 40. The method of clauses 21-33, wherein the foaming agent comprises pMDI, methylene diphenyl diisocyanate (monomeric MDI), or a combination thereof.

Clause 41. The method of clauses 21-33, wherein the mixing of the raw materials mixture and foaming agent is at about 2000 rpm to about 2400 rpm for about 15 to about 20 seconds.

Clause 42. The method of clauses 21-33, wherein the curing is for about 12 to about 36 hours at a temperature of about 50° C. to about 90° C.

Clause 43. The method of clauses 21-33, further comprising demolding the CBF.

Clause 44. The method of clause 43, further comprising curing the CBF for about 12 hours to about 36 hours of curing at about 90° C. to about 120° C. after demolding.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

While the foregoing is directed to embodiments of the present disclosure, other and further embodiments of the disclosure may be devised without departing from the basic scope thereof.

What is claimed is:

1. A composition, comprising:
about 5% to about 20% pyrolysis char (PC) by weight;
about 80% to about 95% lignin solution by weight, wherein the lignin solution comprises:
a lignin; and
a solvent.

2. The composition of claim 1, wherein the solvent comprises:
water;
a polyol; and
a polyisocyanate.

3. The composition of claim 2, wherein a polyisocyanate to water and polyol ratio is from about 0.25 to about 1.25 by weight.

4. The composition of claim 2, wherein a water to polyol ratio is from about 0.5 to about 0.75 by weight.

5. The composition of claim 1, wherein the lignin to PC ratio is from about 0.5 to about 1.0.

6. A carbon based foam (CBF), comprising:
a cured composition, the composition comprising:
about 5% to about 20% pyrolysis char (PC) by weight;
about 80% to about 95% lignin solution by weight, wherein the lignin solution comprises:
a lignin; and
a solvent.

7. The CBF of claim 6, wherein the solvent comprises:
water;
a polyol; and
a polyisocyanate.

8. The CBF of claim 6, wherein a lignin to PC ratio is from about 0.5 to about 1.0.

9. The CBF of claim 6, wherein the CBF has a thermal conductivity of about 0.042 W/m·K to about 0.087 W/m·K.

10. The CBF of claim 6, wherein the CBF has a compression strength of about 200 kPa to about 5000 kPa.

11. A method of making a composition, comprising:
grinding and sieving a pyrolysis char (PC) to form a PC powder;
mixing a lignin with a solvent to form a lignin solution;
mixing the PC powder with the lignin solution to form a lignin-PC solution;
mixing a surfactant and a catalyst with the lignin-PC solution to form a raw materials mixture;
mixing a foaming agent with the raw materials mixture to form a lignin-PC foam; and
curing the lignin-PC foam to form a carbon based foam (CBF).

12. The method of claim 11, wherein the lignin-PC foam comprises:
about 5% to about 20% pyrolysis char (PC) by weight;
about 80% to about 95% lignin solution by weight, wherein the lignin solution comprises:
a lignin; and
a solvent.

13. The method of claim 12, wherein the solvent comprises:
water;
a polyol; and
a polyisocyanate.

14. The method of claim 11, wherein the mixing of the raw materials mixture and foaming agent is at about 2000 rpm to about 2400 rpm for about 15 to about 20 seconds.

15. The method of claim 11, wherein the foaming agent comprises pMDI, methylene diphenyl diisocyanate (monomeric MDI), or a combination thereof.
